(19) United States
(12) Patent Application Publication
(10) Pub. No.: US 2025/0204684 A1
(43) Pub. Date: Jun. 26, 2025

(54) LATERAL WALL FOR A DRAWER

(71) Applicant: Julius Blum GmbH, Hoechst (AT)

(72) Inventor: Martin BISCHOF, Schroecken (AT)

(21) Appl. No.: 19/073,790

(22) Filed: Mar. 7, 2025

Related U.S. Application Data
(63) Continuation of application No. PCT/AT2023/060295, filed on Aug. 30, 2023.

(30) Foreign Application Priority Data
Sep. 9, 2022 (AT) A 50693/2022

(51) Int. Cl. A47B 88/90

(52) U.S. Cl. CPC A47B 88/90

(57) ABSTRACT

A lateral wall for a drawer includes at least one support profile and at least one retaining device for connecting the lateral wall to a drawer rear wall or a drawer front wall. The support profile and the retaining device are formed by a metal material at least in sections and are welded to one another by at least one laser weld seam. The support profile has at least one laser deformation in the region of the laser weld seam, but separate to same, formed by laser light.

The present application is a continuation of International Application PCT/AT2023/060295 filed on Aug. 30, 2023. Thus, all of the subject matter of International Application PCT/AT2023/060295 is incorporated herein by reference.

### BACKGROUND OF THE INVENTION

The invention relates to a lateral wall for a drawer and to a method for producing such a lateral wall.

Lateral walls for a drawer are known from the prior art and comprise a support profile and a retaining device for connecting the lateral wall to a drawer rear wall or a drawer front wall, wherein the support profile and the retaining device are formed at least in sections by a metal material and are welded to one another by means of a laser weld seam.

However, there is a risk that the retaining device will detach from the support profile again under a certain load, e.g. when the inclination of a drawer front wall is adjusted using a railing bar.

### SUMMARY OF THE INVENTION

The object of the present invention is to provide a lateral wall which is improved compared to the prior art and a method for producing such an improved lateral wall, wherein the lateral wall is characterized in particular by a higher load-bearing capacity without the retaining device becoming detached from the support profile.

In the case of the lateral wall, the support profile in the region of the at least one laser weld seam has at least one separate laser deformation caused by laser light. An additional laser treatment is therefore carried out in the welding region. This makes the rail more stable and also makes the retaining device less likely to break off. In other words, during the welding operation for fastening the at least one retaining device, heat is additionally introduced into the at least one support profile with the aid of a laser. This causes the support profile to deform slightly and bend upwards. Thus, stresses are deliberately generated in the support profile, which result in a preferential deformation. With certain material qualities, structural changes can also occur, resulting in a hardening process. Due to the additional laser treatment, the at least one support profile can bear greater loads, whereby higher loads on the drawer rear wall or drawer front wall connected to the at least one retaining device are possible. This is advantageous, for example, if the inclination adjustment of the drawer front wall is achieved via a railing bar.

Analogously, in a method of producing a lateral wall for a drawer according to the invention it is provided that the at least one support profile and the at least one retaining device are welded to one another by means of at least one laser weld seam and in the region of the at least one laser weld seam, a laser deformation separate from the at least one laser weld seam is caused by irradiation with laser light.

According to a preferred embodiment of the lateral wall, the at least one laser weld seam is arranged predominantly at locations on the at least one support profile at which the at least one retaining device and the at least one support profile are in contact. In the method it can be correspondingly provided that the at least one laser weld seam is arranged predominantly at locations on the at least one support profile at which the at least one retaining device and the at least one support profile are in contact.

Alternatively or additionally, the at least one laser deformation is arranged predominantly at locations on the at least one support profile at which the at least one retaining device and the at least one support profile are not in contact. In other words, the at least one retaining device and the at least one support profile are designed without a contact at these locations. In the method it can be correspondingly provided that the at least one laser deformation is arranged predominantly at locations on the at least one support profile at which the at least one retaining device and the at least one support profile are not in contact.

A further advantageous embodiment of the lateral wall is characterized in that the at least one laser deformation is arranged offset to the at least one laser weld seam on the at least one support profile. In the method it can be correspondingly provided that the at least one laser deformation is arranged offset to the at least one laser weld seam on the at least one support profile.

It has proved to be advantageous if the at least one laser deformation and the at least one laser weld seam have at least one intersection point, and/or that the at least one laser deformation extends in a direction transverse to a longitudinal direction of the at least one support profile over a greater width than the at least one laser weld seam, and/or the at least one laser deformation is formed at least in sections linearly and/or has a zig-zag shape. In the method it can be correspondingly provided that the at least one laser deformation and the at least one laser weld seam are arranged relative to one another in such a way that the laser deformation and the at least one laser weld seam have at least one intersection point, and/or that the at least one laser deformation extends in a direction transverse to a longitudinal direction of the at least one support profile over a greater width than the at least one laser weld seam, and/or the at least one laser deformation is formed at least in portions linearly in a zig-zag shape.

A particularly preferred embodiment of the lateral wall is characterized in that the at least one laser weld seam and the at least one laser deformation are linear at least in portions. The laser weld seam and the laser deformation have a different line width, and preferably the laser deformation has a larger line width than the laser weld seam. In the method it can be correspondingly provided that the at least one laser weld seam and the at least one laser deformation are produced with the same laser, wherein the focus of the laser is adjusted, preferably widened, after the production of the laser weld seam and before the production of the at least one laser deformation.

And finally, it has proven to be advantageous in the case of the lateral wall that the at least one retaining device and the at least one support profile contact one another in sections on a first side of the support profile, and wherein the at least one laser weld seam and the at least one laser deformation are arranged on a second side which is opposite the first side and is spaced from the first side by a material thickness of the support profile, preferably wherein, in the position of use of the lateral wall, the first side is an upwardly directed upper side and the second side is a downwardly directed lower side of the support profile. In the method it can be correspondingly be provided that the at least one retaining device and the at least one support profile contact one another in sections on a first side of the support profile, and wherein the at least one laser weld seam and the at least one laser deformation are arranged on a second side which is opposite the first side and is spaced from the first side by a material thickness of the support profile, preferably wherein, in the position of use of the lateral wall, the first side is an upwardly directed upper side and the second side is a downwardly directed lower side of the support profile.

### BRIEF DESCRIPTION OF THE DRAWINGS

Further details and advantages of the invention are explained in more detail below with reference to the drawings, in which:

FIGS. 1, 2 show a lateral wall for a drawer in a perspective view, FIG. 1, and in a schematic plan view from the side, FIG. 1,

FIGS. 3, 4 show the support profile of the lateral wall with a retaining device in a perspective view from above, FIG. 3, and partially from below, FIG. 4, the section 17 in FIG. 3 being shown additionally enlarged, and

FIGS. 5-8 show the support profile of the lateral wall respectively in a plan view from below, wherein FIG. 5 shows the entire support profile and FIGS. 6 to 8 show the section 19.

### DETAILED DESCRIPTION OF THE INVENTION

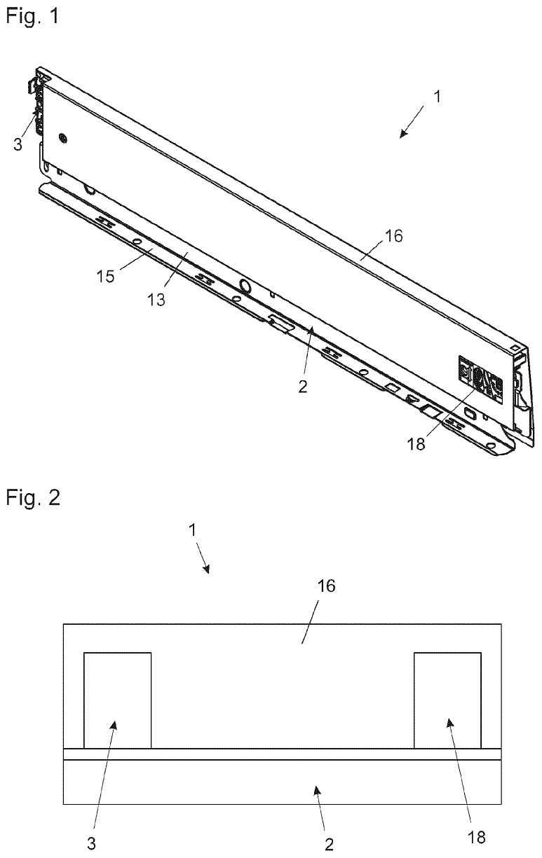

FIGS. 1 and 2 show a lateral wall 1 for a drawer, comprising at least one support profile 2 and at least one retaining device 3, 18 for connecting the lateral wall 1 to a drawer rear wall or a drawer front wall. The retaining device 3 is arranged, in the position of use of the lateral wall 1, in a rear region and is designed to connect the lateral wall 1 to a drawer rear wall. The retaining device 18 is arranged, in the position of use of the lateral wall 1, in a front region and is designed to connect the lateral wall 1 to a drawer rear wall. The support profile 2 can also be referred to as a container rail.

The lateral wall 1 can be connected to an extraction guide (not shown). The support profile 2 comes into contact with a drawer rail of the pull-out guide that can be moved relative to a carcass rail. The retaining devices 3 and 18 can be arranged in regions in a hollow profile 16 which is connected or connectable to the support profile 2.

The invention is explained in the following figures using the example of the retaining device 3. Alternatively or additionally, it can be used with the retaining device 18.

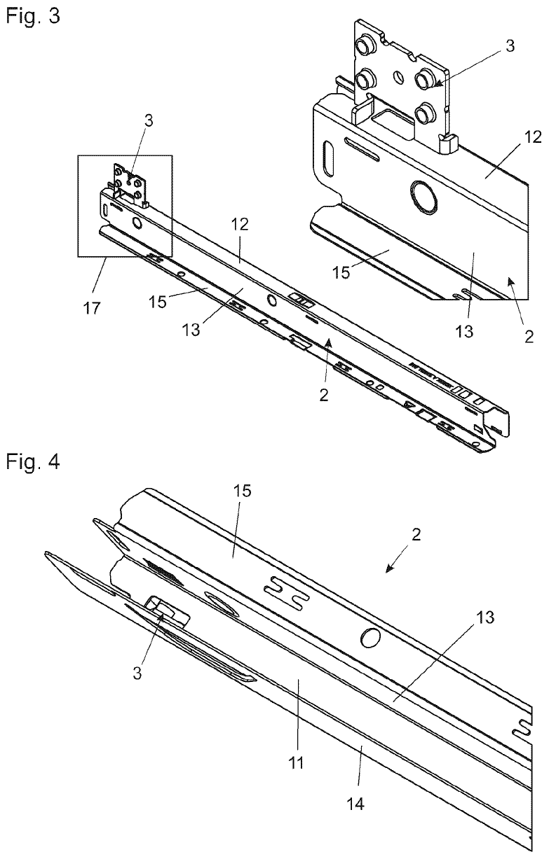

FIGS. 3 and 4 show the support profile 2 of the lateral wall 1 with the retaining device 3 in a perspective view from above and partially from below, wherein section 17 in FIG. 3 is additionally shown enlarged.

As in the case shown, the support profile 2 can have a horizontal web with a first side 11 and a second side 12, which is opposite the first side 11 and is spaced from the first side 11 by a material web of the support profile 2. The support profile 2 can have a first vertical web 13 and a second vertical web 14 connected to the horizontal web, wherein the vertical webs 13 and 14 are spaced apart from one another and run essentially parallel to one another. The support profile 2 can have a support web 15 for a drawer bottom.

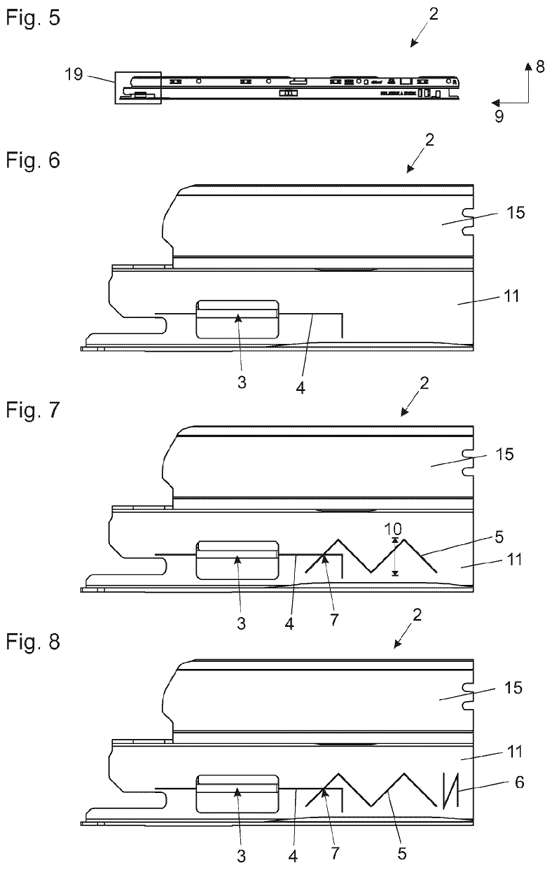

FIGS. 5-8 show the support profile 2 of the lateral wall 1 respectively in a plan view from below, wherein FIG. 5 shows the entire support profile 2 and FIGS. 6 to 8 show section 19.

The support profile 2 and the retaining device 3 are formed at least in sections from a metal material and welded to one another by means of at least one laser weld seam 4. The at least one laser weld seam 4 is arranged predominantly at locations on the at least one support profile 2 at which the at least one retaining device 3, 18 and the at least one support profile 2 are in contact.

In the region of the at least one laser weld seam 4, the support profile 2 has at least one separate laser deformation 5, 6 caused by laser light. The at least one laser deformation 5, 6 is arranged predominantly at locations on the at least one support profile 2 at which the at least one retaining device 3, 18 and the at least one support profile 2 are not in contact.

For example, as shown in FIG. 7 by way of example, only one laser deformation 5 or, as shown in FIG. 8 by way of example, two laser deformations 5 or 6 may be provided. The laser deformations 5, 6 are arranged offset to the at least one laser weld seam 4 on the at least one support profile 2. The laser deformations 5 and the laser weld seam 4 have an intersection point 7.

The laser deformations 5, 6 extend in a direction 8 transverse to a longitudinal direction 9 of the at least one support profile 2 over a greater width 10 than the at least one laser weld seam 4.

The laser deformations 5, 6 are at least in sections linear and have a zig-zag shape, e.g. in the shape of an “N”.

The laser weld seam 4 and the laser deformations 5, 6 are formed linearly at least in sections, wherein the laser weld seam 4 and the laser deformation 5, 6 have a different line width, preferably wherein the laser deformation 5, 6 has a greater line width than the laser weld seam 4. These different line widths can be caused by the fact that the laser weld seam 4 and the laser deformations 5, 6 are produced with the same laser, wherein the focus of the laser is adjusted, preferably widened, after the production of the laser weld seam 4 and before the production of the at least one laser deformation 5, 6.

1. A lateral wall for a drawer, comprising:
at least one support profile, and
at least one retaining device for connecting the lateral wall to a drawer rear wall or a drawer front wall,
wherein the support profile and the retaining device are formed at least in sections by a metal material and are welded to one another by at least one laser weld seam,
wherein the support profile has at least one separate laser deformation in the region of the at least one laser weld seam, which is formed by laser light.

2. The lateral wall according to claim 1, wherein the at least one laser weld seam is arranged predominantly at locations on the at least one support profile at which the at least one retaining device and the at least one support profile are in contact.

3. The lateral wall according to claim 1, wherein the at least one laser deformation is arranged predominantly at locations on the at least one support profile at which the at least one retaining device and the at least one support profile are not in contact.

4. The lateral wall according to claim 1, wherein the at least one laser deformation is arranged offset to the at least one laser weld seam on the at least one support profile.

5. The lateral wall according to claim 1, wherein the at least one laser deformation and the at least one laser weld seam have at least one intersection point.

6. The lateral wall according to claim 1, wherein the at least one laser deformation extends in a direction transverse to a longitudinal direction of the at least one support profile over a greater width than the at least one laser weld seam.

7. The lateral wall according to claim 1, wherein the at least one laser deformation is formed at least in sections linearly and/or has a zig-zag shape.

8. The lateral wall according to claim 1, wherein the at least one laser weld seam and the at least one laser deformation are formed linearly at least in sections, and wherein the laser weld seam and the laser deformation have a different line width, preferably wherein the laser deformation has a greater line width than the at least one laser weld seam.

9. The lateral wall according to claim 1, wherein the at least one retaining device and the at least one support profile contact one another in sections on a first side of the support profile, and wherein the at least one laser weld seam and the at least one laser deformation are arranged on a second side, which is opposite the first side and is spaced from the first side by a material thickness of the support profile, preferably wherein, in the position of use of the lateral wall, the first side is an upwardly directed upper side and the second side is a downwardly directed lower side of the support profile.

10. A method for producing the lateral wall according to claim 1, the method comprising:
welding together the at least one support profile and the at least one retaining device by at least one laser weld seam, and
forming a laser deformation separate from the at least one laser weld seam in the region of the at least one laser weld seam by irradiation with laser light.

11. The method according to claim 10, wherein:
the at least one laser weld seam is arranged predominantly at locations on the at least one support profile at which the at least one retaining device and the at least one support profile are in contact, and/or
the at least one laser deformation is arranged predominantly at locations on the at least one support profile at which the at least one retaining device and the at least one support profile are not in contact, and/or
the at least one laser deformation is arranged offset to the at least one laser weld seam on the at least one support profile.

12. The method according to claim 10, wherein the at least one laser deformation and the at least one laser weld seam are arranged relative to one another in such a way that the laser deformation and the at least one laser weld seam have at least one intersection point, and/or in that the at least one laser deformation extends in a direction transverse to a longitudinal direction of the at least one support profile over a greater width than the at least one laser weld seam.

13. The method according to claim 10, wherein the at least one laser deformation is formed at least in sections linearly in the form of a zigzag.

14. The method according to claim 10, wherein the at least one laser weld seam and the at least one laser deformation are produced with the same laser, wherein the focus of the laser is adjusted, preferably widened, after the production of the laser weld seam and before the production of the at least one laser deformation.

15. The method according to claim 10, wherein the at least one retaining device and the at least one support profile contact one another in sections on a first side of the support profile, and wherein the at least one laser weld seam and the at least one laser deformation are arranged on a second side, which is opposite the first side and is spaced from the first side by a material thickness of the support profile, preferably wherein, in the position of use of the lateral wall, the first side is an upwardly directed upper side and the second side is a downwardly directed lower side of the support profile.
